(19) United States
(12) Patent Application Publication
(10) Pub. No.: US 2014/0029672 A1
(43) Pub. Date: Jan. 30, 2014

(54) METHOD OF CODING A SEQUENCE OF IMAGES AND CORRESPONDING RECONSTRUCTION METHOD

(71) Applicants: Safa Cherigui, Villeurbannes (FR); Dominique Thoreau, Cesson Sevigne (FR); Christine Guillemot, Chantepie (FR); Philippe Guillotel, Cesson Sevigne (FR)

(72) Inventors: Safa Cherigui, Villeurbannes (FR); Dominique Thoreau, Cesson Sevigne (FR); Christine Guillemot, Chantepie (FR); Philippe Guillotel, Cesson Sevigne (FR)

(73) Assignee: THOMSON LICENSING, Issy de Moulineaux (FR)

(21) Appl. No.: 13/980,887

(22) PCT Filed: May 24, 2011
(86) PCT No.: PCT/EP11/58474

§ 371 Date: Oct. 11, 2013

(30) Foreign Application Priority Data
Jan. 21, 2011 (EP) 11305064.5

(51) Int. Cl. H04N 7/34

(52) U.S. Cl. CPC H04N 19/00763
USPC 375/240.16

(57) ABSTRACT

A method of coding a sequence of images is disclosed. The method of coding comprises for a current image the steps of:
creating a summary of said current image;
encoding said summary into a first bitstream;
reconstructing an intermediate image from said summary; and
encoding, into a second bitstream, the current image using said intermediate image as reference image.

### 1. FIELD OF THE INVENTION

The invention relates to video coding and decoding. More particularly, it concerns a method of coding a sequence of images and a method of reconstruction of the sequence. It addresses the improvement of the video coding performance by keeping the same quality for a lower bit-rate.

### 2. BACKGROUND OF THE INVENTION

When encoding an image of a sequence of images, it is known to first predict the image either spatially or temporally and to encode the residual signal resulting from the prediction of the image. Spatial prediction is also referred to as INTRA prediction and temporal prediction is also referred to as INTER prediction. The ITU-T Rec. H.264/ISO/IEC 14496-10 AVC video coding standard specifies three different intra prediction modes, Intra4×4, Intra8×8 and Intra16×16 that correspond to a spatial estimation of the block to be coded. These different modes can exploit different directional prediction modes in order to build the pixels of the prediction block. In Intra4×4 and Intra8×8, nine intra prediction modes are defined. Eight of these modes consist of a 1D directional extrapolation of pixels surrounding the block to be predicted. The additional prediction mode (DC mode) defines the pixels of the prediction block as the average of available surrounding pixels.

When the texture corresponds to mono-directional oriented structures, fitting with one of the available prediction directions, these structures can be well extrapolated with the appropriate directional 1D prediction. But in case of complex 2D patterns, H.264/AVC intra prediction modes are not able to correctly propagate and predict the signal.

### 3. BRIEF SUMMARY OF THE INVENTION

The invention is aimed at alleviating at least one of the drawbacks of the prior art. One aim of the invention is to improve the principle of intra prediction, and this by using a coder/decoder scheme based an image summary (e.g. an epitome) of the current image, in which the image summary is indirectly used as a reference image.

Thus, the invention relates to a method of coding a sequence of images comprising for a current image the steps of:
creating a summary of the current image;
encoding the summary into a first bitstream;
reconstructing an intermediate image of same size as the current image from the summary; and
encoding, into a second bitstream, the current image using the intermediate image as reference image.
According to an aspect of the invention, the summary of the current image comprises a texture epitome and an assignation map.
Advantageously, the assignation map is encoded using fixed length coding or using variable length coding.
Advantageously, the second bitstream is in conformance with one video coding standard belonging to the set of video coding standards comprising:
ITU-T Rec. H.264/ISO/IEC 14496-10 AVC video coding Standard; and
ISO/IEC 13818-2 MPEG2.

The invention further relates to a method of reconstructing a sequence of images comprising for a current image the steps of:
decoding an image summary of a current image;
reconstructing an intermediate image from the summary; and
reconstructing the current image using the intermediate image as reference image, the intermediate image being of same size as the current image.

The use of image summary is solving the issue of directional intra prediction by using 2D texture prediction. Indeed, a summary image is composed of real texture and come only from the original image. The main purpose of a summary image is to remove redundancy within the original image and to keep the most pertinent patterns (or patches) that best represent the image texture. These patterns could provide a prediction more suitable for 2D texture since 2D patches are considered instead of oriented mono-directional interpolations.

### 4. BRIEF DESCRIPTION OF THE DRAWINGS

Other characteristics and advantages of the invention will appear through the description of a non-limiting embodiment of the invention, which will be illustrated, with the help of the enclosed drawing.

FIG. 1 depicts the method of coding according to a first embodiment of the invention;

FIG. 2 depicts the method of coding according to a second embodiment of the invention;

FIG. 3 illustrates the creation of an epitome and the reconstruction of an image from the epitome according to the prior art;

FIG. 4 represents a detail of the method of coding according to the second embodiment of the invention;

FIG. 5 represents a given image block Bᵢ to be match with the set of matched patches delimited by the white line on the right image with error tolerance ε;

FIG. 6 represents a chart initialization step: on the left, grey blocks in the image are the blocks currently reconstructed by the current chart, the current epitome ECₙ being initially represented by a single patch E₀;

FIG. 7 represents a chart extension step;

FIG. 8 represents an example of an epitome (b) created from an original image (a), and an image reconstructed from the epitome (c);

FIG. 9 depicts the method of reconstruction according to a first embodiment of the invention;

FIG. 10 depicts the method of reconstruction according to a second embodiment of the invention;

FIG. 11 represents a coding device according to the invention; and

FIG. 12 represents a decoding device according to the invention.

### 5. DETAILED DESCRIPTION OF THE INVENTION

The invention relates to a coding method of a sequence of images. The method of coding is described for a current image of the sequence. The method of coding according to the invention uses an image summary of the current image in order to encode it. The invention further relates to a corresponding reconstruction method.

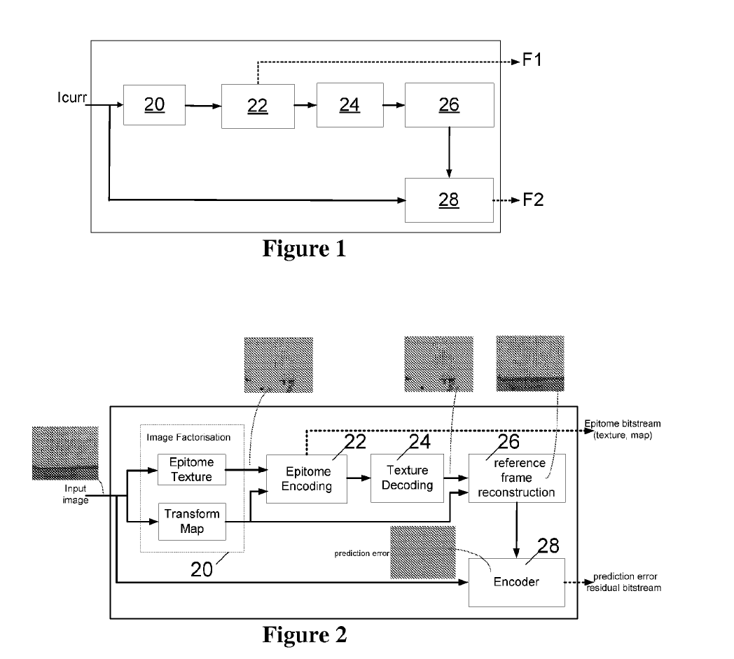

FIG. 1 represents the coding method according to the invention.

At step 20, an image summary is created from the current image Icurr. According to a specific embodiment the image summary is an epitome. However, the invention is not limited to this kind of summary. Any kind of summary (e.g. patch dictionary) may be used provided that an image is able to be reconstructed from this summary.

At step 22, the image summary is encoded into a first stream F1. As an example the summary is encoded in conformance with H.264 standard using intra only coding modes. According to a variant, the image summary is encoded in conformance with JPEG standard defined in document JPEG 2000 Part, ISO/IEC JTC1/SC 29/WG 1 Std., March 2000

At step 24, the image summary is decoded into a decoded summary. The step 24 is the inverse of step 22.

At step 26, an intermediate image is reconstructed from the decoded summary.

At step 28, the current image Icurr is encoded using the intermediate image as reference image into a second bitstream F2. As an example, the current image is encoded in conformance with H.264. According to a variant, the current image is encoded in conformance with the MPEG2 ISO-IEC 13818 video coding Standard. Usual coding modes (inter and intra coding modes) may be used. When a block of the current image is encoded according to inter coding mode then the difference between the block and a corresponding block in the reference image, i.e. in the image intermediate image reconstructed from the decoded epitome, is encoded. The corresponding block is identified in the reference image by a motion vector or may be the colocalized block in the reference image. Bidirectional prediction is also possible with two blocks of the reference image. The difference also known as residue is in fact the prediction error calculated between the block and its prediction derived from the reference image. Usually, the residue is first transformed into a block of coefficients such as DCT coefficients. The coefficients are then quantized into a block of quantized coefficients. The quantized coefficients are finally encoded into a bitstream using entropy coding such as well known arithmetic coding, CABAC (which stands for Context-Adaptive Binary Arithmetic Coding), CAVLC (which stands for Context-Adaptive Variable-Length Coding), etc. The invention is not limited to the type of encoding used to encode the residues. The bitstream F2 is the prediction error residual bitstream. According to a variant, the first and second bitstreams are multiplexed into a single bitstream.

FIG. 2 represents the coding method according to a specific embodiment of the invention wherein the image summary is an epitome. The epitome of an image is its condensed representation containing the essence of the textural and structure properties of the image.

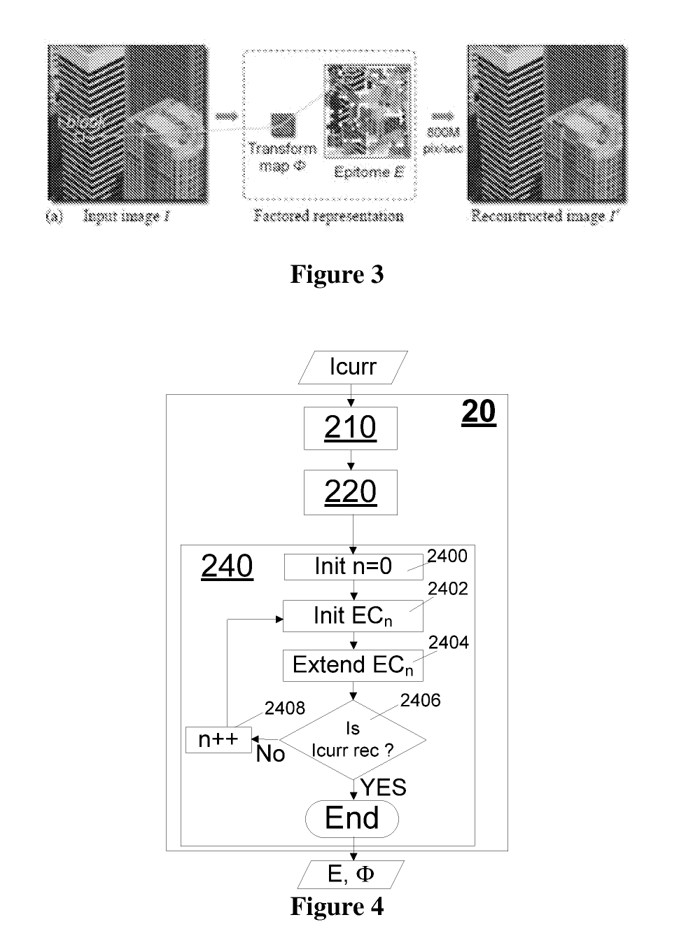

At step 20, an epitome is created from the current image Icurr. Therefore, according to this specific embodiment, the current image Icurr is factorized, i.e. a texture epitome E and a transform map Φ are created for the current image. The epitome principle was first disclosed by Hoppe et al in the article entitled “Factoring Repeated Content Within and Among Images” published in the proceedings of ACM SIGGRAPH 2008 (ACM Transaction on Graphics, vol. 27, no. 3, pp. 1-10, 2008). The texture epitome E is constructed from pieces of texture (e.g. a set of charts) taken from the current image. The transform map Φ is an assignation map that keeps track of the correspondences between each block of the current image Icurr and a patch of the texture epitome E. FIG. 3 illustrates the method of Hoppe. From an image I, a texture epitome E and a transform map Φ are created such that all image blocks can be reconstructed from matched epitome patches. A matched patch is also known as transformed patch. The transform map is also known as vector map or assignment map in the literature. With the texture epitome E and the transform map Φ, one is able to reconstruct the current image I′. In the following the epitome designates both the texture epitome E and the transform map Φ. FIG. 4 illustrates a method for epitome creation. However, the invention is not at all limited to this method of epitome creation. Others forms of epitome have been proposed in the literature. In document entitled “Summarizing visual data using bidirectional similarity” published in 2008 in Computer Vision and Pattern Recognition CVPR, Simakov et al disclose the creation of an image summary from a bi-directional similarity measure. Their approach aims at satisfying two requirements: containing as much as possible visual information from the input data while introducing as few as possible new visual artifacts that were not in the input data (i.e., while preserving visual coherence).

In document entitled “Video Epitomes” published in International Journal of Computer Vision, vol. 76, No. 2, February 2008 image Cheung et al disclose a statistical method in order to extract an epitome. This approach is based on a probabilistic model that captures both the color information and certain spatial pattern.

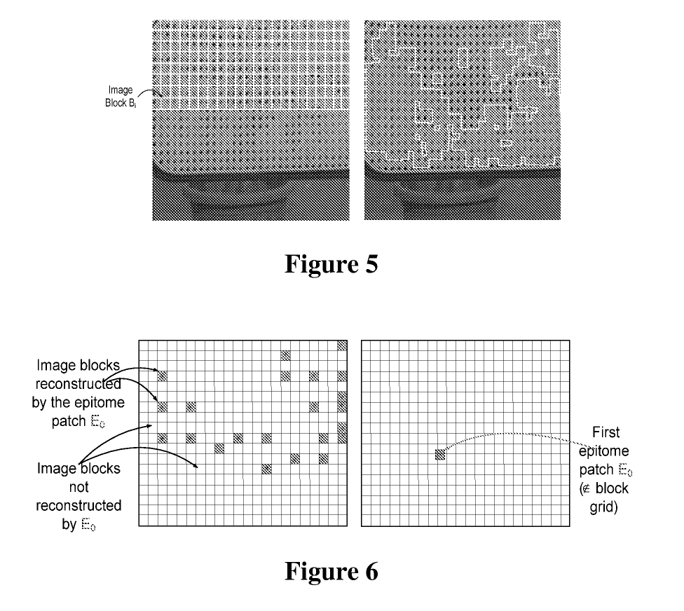

At step 210, the epitome construction method comprises finding self-similarities within the current image Icurr. The current image is thus divided into a regular grid of blocks. For each block in the current image Icurr, one searches the set of patches in the same image with similar content. That is, for each block Bᵢ(∈block grid), a list L_{match}(Bᵢ)={M_{i,0},M_{i,1}, . . . } of matches (or matched patches) is determined that approximate Bᵢ with a given error tolerance ε. In the current embodiment, the procedure of matching is performed with a block matching algorithm using an average Euclidian distance. Therefore, at step 210, the patches M_{j,l} in the current image whose distance to the block Bi is below ε are added to the list L_{match}(Bᵢ). The distance equals for example the absolute value of the pixel by pixel difference between the block Bi and the patch M_{j,l} divided by the number of pixels in Bᵢ. According to a variant, the distance equals the SSE (Sum of Square Errors), wherein the errors are the pixel by pixel difference between the block Bi and the patch M_{j,l}. An exhaustive search is performed in the entire image. Once all the match lists have been created for the set of image blocks new lists L′_{match}(M_{j,l})indicating the set of image blocks that could be represented by a matched patch M_{j,l}, are built at step 220. Note that all the matched blocks M_{j,i} found during the full search step are not necessarily aligned with the block grid of the image and thus belong to the “pixel grid” as shown in FIG. 5.

At step 240, epitome charts are constructed. To this aim, texture patches are extracted, more precisely selected, in order to construct epitome charts, the union of all the epitome charts constituting the texture epitome E. Each epitome chart represents specific regions of the image in term of texture.

Step 240 is detailed in the following.

At step 2400, an index n is set equal to 0, n is an integer.

At step 2402, a first epitome chart ECₙ is initialized. Several candidate matched patches can be used to initialize an epitome chart. Each epitome chart is initialized by the matched patch which is the most representative of the not yet reconstructed remaining blocks. Let Y ∈ R^{N×M} denote the input image and let Y′ 531 R^{N×M} denote the image reconstructed by a candidate matched patch and the epitome charts previously constructed. To initialize a chart, the following selection criterion based on the minimization of the Mean Square Error (MSE) criterion is used:

$${FC}_{init} = min ( \frac{{\sum }_{i = 1}^{N} {\sum }_{j = 1}^{M} ( {Y}_{i , j} - {Y}_{i , j}^{′} )}{N \times M} ) \qquad ( 1 )$$

The selected criterion takes into account the prediction errors on the whole image. This criterion allows the epitome to be extended by a texture pattern that allows the reconstruction of the largest number of blocks while minimizing the reconstruction error. In the current embodiment, a zero value is assigned to image pixels that have not yet been predicted by epitome patches when computing the image reconstruction error. FIG. 6 shows the image blocks reconstructed once the first epitome patch E0 is selected.

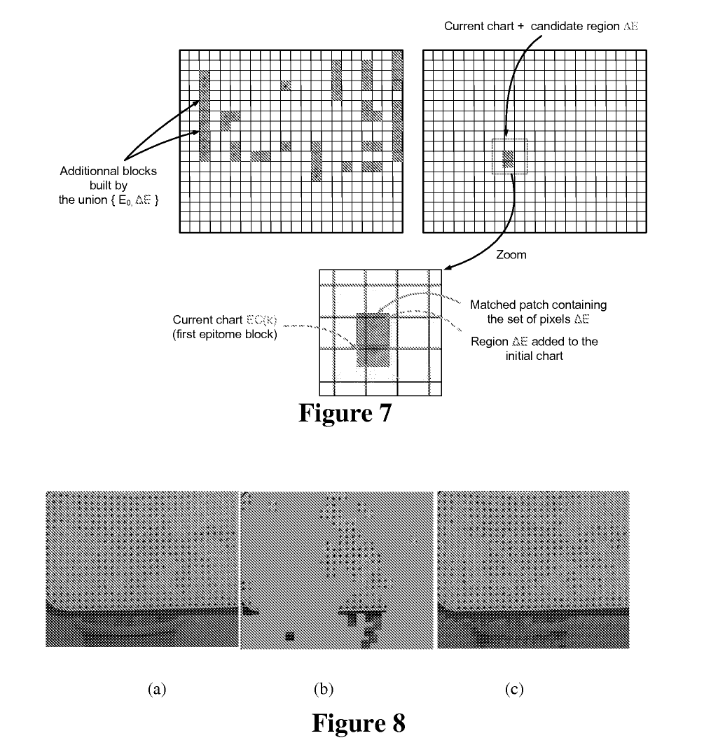

At step 2404, the epitome chart ECₙ is then progressively grown by a region from the input image, and each time the epitome chart is enlarged, one keeps track of the number of additional blocks which can be predicted in the image as depicted on FIG. 7. This step is also known as epitome chart extension. The initial epitome chart ECₙ(0) corresponds to the texture patch retained at the initialization step. The epitome growth step proceeds first by determining the set of matched patches M_{j,l} that overlap the current chart ECₙ(k) and represent other image blocks. Therefore, there are several candidates regions ΔE that can be used as an extension of the current epitome chart. For each chart growth candidate ΔE, the supplement image blocks that could be reconstructed is determined from the list L′_{match}(M_{j,k}) related only to the matched patch M_{j,k} containing the set of pixels ΔE. Then, the optimal candidate ΔEₒₚₜ among the set of the candidate chart growth found, leading to best match according to a rate distorsion criterion is selected. Let Y ∈ R^{N×M} denote the input image and let Y′ ∈ R^{N×M} denote the image reconstructed by the current epitome E_{curr} and a chart growth candidate ≢E. Note that the current epitome E_{curr} is composed of previously constructed epitome charts and the current epitome chart ECₙ(k). This selection is indeed conducted according to a minimization of a lagrangian criterion FCₑₓₜ

$${FC}_{ext} = min ( {D}_{{E}_{curr} + Δ E} + λ * {R}_{{E}_{curr} + Δ E} + Δ E )$$

$$with$$

$${E}_{curr} = {\sum }_{i = 0}^{n} {EC}_{i}$$

$$Δ {E}_{opt}^{k} = {arg min}_{m} ( \frac{{\sum }_{i}^{N} {\sum }_{j}^{M} ( {Y}_{i , j} - {Y}_{i , j}^{′} )}{N * M} + λ * ( \frac{{E}_{curr} + Δ E}{N * M} ) )$$

In the preferred embodiment, the λ value is set to 1000. The first term of the criterion refers to the average prediction error per pixel when the input image is reconstructed by texture information contained in the current epitome

$${E}_{curr} = {\sum }_{i = 0}^{n} {EC}_{i}$$

and the increment ΔE. As in the initialization step when the image pixels are impacted neither by the current epitome E_{curr} nor by the increment, a zero value is assigned to them. FCₑₓₜ is thus computed on the whole image and not only on the reconstructed image blocks. The second term of the criterion corresponds to a rate per pixel when constructing the epitome, which is roughly estimated as the number of pixels in the current epitome and its increment, divided by the total number of pixels in the image. After having selected the locally optimal increment ΔEₒₚₜ, the current epitome chart becomes: ECₙ(k+1)=ECₙ(k)+ΔEₒₚₜ. The assignation map is updated for the blocks newly reconstructed by ECₙ(k+1).

Then, the current chart is extended, during next iteration k+1, until there are no more matched patches M_{j,l} which overlap the current chart ECₙ(k) and represent others blocks. If such overlapping patches exist then the method continues at step 2404 with ECₙ(k+1). When the current chart cannot be extended anymore and when the whole image is not yet reconstructed by the current epitome (step 2406), the index n is incremented by 1 at step 2408 and another epitome chart is created at a new location in the image. The method thus continues with the new epitome chart at step 2402, i.e. the new chart is first initialized before its extension. The process ends when the whole image is reconstructed by the epitome (step 2406). An example of a texture epitome is given by the FIG. 8b (this epitome is composed of 9 epitome charts). FIG. 8a represents the image Icurr from which the epitome of FIG. 8b is created. The texture epitome E comprises the union of all epitome charts ECₙ. The assignation map indicates for each block Bi of the current image the location in the texture epitome of the patch used for its reconstruction.

Once an epitome is created for an image, an approximation of this image can be reconstructed from the texture epitome and the transform map. However, due to the error tolerance ε, there are remaining differences between the original image and the reconstructed one. For video coding applications, it is thus necessary to further encode those remaining differences. Back to FIG. 2, at step 22, the epitome (E, Φ) are encoded into a first stream F1. The texture epitome E is encoded with as intra only encoder. As an example the texture epitome E is encoded in conformance with H.264 standard using intra only coding mode. According to a variant, the texture epitome is encoded in conformance with JPEG standard. According to another variant, the texture epitome is encoded in inter coding mode using as reference image an homogenous image, e.g. an image whose pixels all equal 128. According to another variant, the texture epitome is encoded using a classical encoder (e.g. H.264, MPEG2, etc) using both intra and inter prediction modes. These methods usually comprise the steps of computing a residual signal from a prediction signal, DCT, quantization and entropy coding. The transform map Φ is encoded with a fixed length code (FLC) or variable length code (VLC). But others can be used also (CABAC . . . ). The transform map is a map of vectors also referred as vector map.

At step 24, the texture epitome E is decoded. This step is the inverse of the texture epitome coding step, entropy coding apart. As an example, if the texture epitome coding step comprises computing a residual signal from a prediction signal, DCT and quantization then the decoding step 24 comprises dequantization, inverse DCT and adding the prediction signal to the residual signal in order to get a reconstructed signal.

At step 26, an intermediate image is reconstructed from the decoded texture epitome E and from the transform map Φ.

An example of an intermediate image reconstructed from the epitome of FIG. 8b is shown in FIG. 8c. The image blocks are processed in raster scan. The reconstruction may be a simple copy of the patch identified thanks to the transform map. If sub-pel reconstruction is used then an interpolation is made. At step 28, the current image is encoded using the intermediate image as reference image. As an example, the current image is encoded in conformance with H.264 video coding Standard. According to a variant, the current image is encoded in conformance with MPEG2 video coding Standard. Usual coding modes (inter and intra coding modes) may be used. When a block of the current image is encoded according to inter coding mode then the difference between the block and a corresponding block in the reference image, i.e. in the image intermediate image reconstructed from the decoded epitome, is encoded. The corresponding block is identified in the reference image by a motion vector that is also encoded. Bidirectionnal prediction is also possible. According to a variant, no motion vector is encoded and colocalized block in the reference image are used. The difference also known as residue is in fact the prediction error calculated between the block and its prediction derived from the reference image.

Usually, the residue is first transformed into a block of coefficients such as DCT coefficients. The coefficients are then quantized into a block of quantized coefficients. The quantized coefficients are finally encoded into a bitstream using entropy coding such as well known arithmetic coding, CABAC (which stands for Context-Adaptive Binary Arithmetic Coding), CAVLC (which stands for Context-Adaptive Variable-Length Coding), etc. The invention is not limited to the type of encoding used to encode the residues. The bitstream F2 is the prediction error residual bitstream.

According to a variant, the first and second bitstreams are multiplexed into a single bitstream.

The method of coding according to the specific embodiment of FIG. 3 comprises tracking self-similarities, according to a given error tolerance ε within an image current Icurr so as to build a texture epitome E for instance based on a simple block matching technique. The epitome is then constructed from pieces of texture taken from the input image Icurr and a map of vectors, called assignation map, which here contains simple translational parameters and keeps track of the correspondences between each block of the input image and a block of the epitome.

Secondly, an intermediate image is reconstructed from the texture epitome and the assignation map. Finally the current image Icurr is encoded using the reconstructed image Irec as reference image in the sense of inter image prediction. The steps of the encoding method according to the specific embodiment are summarized as follows:
1. Building an epitome of a current image Icurr (composed of a texture epitome and of an assignation map), more generally building an image summary of Icurr;
2. Encoding the epitome (texture and map) into a first bitstream;
3. Reconstructing an image from the decoded texture epitome and map;
4. Encoding, into a second bitstream, the current image Icurr using the intermediate image Irec as reference image so as to use it as prediction in the spirit of SNR scalability, and

The two bitstreams F1 and F2 (the one relative to the texture epitome and assignation map of the encoded epitome and the one relative to the current image Icurr) are finally either sent to a decoder or stored on a storage medium such as a hard disk or DVD.

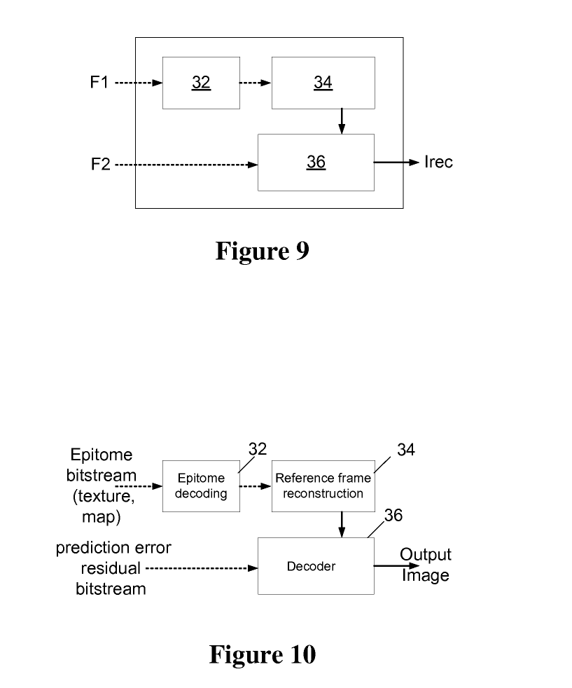

FIG. 9 represents the reconstruction method according to the invention.

At step 32, an image summary is decoded from a first bitstream F1. Cette étape est I'étape inverse de I'étape 22 du procédé de codage.

At step 34, the image summary is used to reconstruct an intermediate image. This step is identical to step 26 of the coding method.

At step 36, the current image is reconstructed using the intermediate image as reference image. When a block of the current image is encoded according to inter coding mode then the difference between the block and a corresponding block in the reference image, i.e. in the intermediate image reconstructed from the decoded epitome, is decoded. The corresponding block is identified in the reference image by a motion vector. Bidirectional prediction with two blocks of the reference image is possible. According to a variant, no motion vector is encoded and colocalized block in the reference image are used. The difference is in fact the prediction error calculated, on the encoder side, between the block and its prediction derived from the reference image. Usually, quantized coefficients are first decoded from a second bitstream using entropy decoding such as well known arithmetic coding, CABAC, CAVLC, etc. The quantized coefficients are then dequantized into a block of dequantized coefficients such as DCT coefficients. The dequantized coefficients are finally transformed, e.g. using an inverse DCT, into a block of residues. The block of residues is then added to a corresponding block in the reference image.

According to a variant, the reconstruction method further comprises a step 30 of demultiplexing a bitstream into the first and the second bitstreams when the first and the second bitstream are multiplexed.

According to a specific embodiment depicted on FIG. 10 the image summary is an epitome. Therefore, the step 32 comprises decoding a texture epitome and assignation map of vectors.

The image reconstruction of the intermediate image is realized symmetrically at the encoder and at the decoder sides from the decoded texture epitome and assignation map in order to avoid any drift when reconstructing the current image.

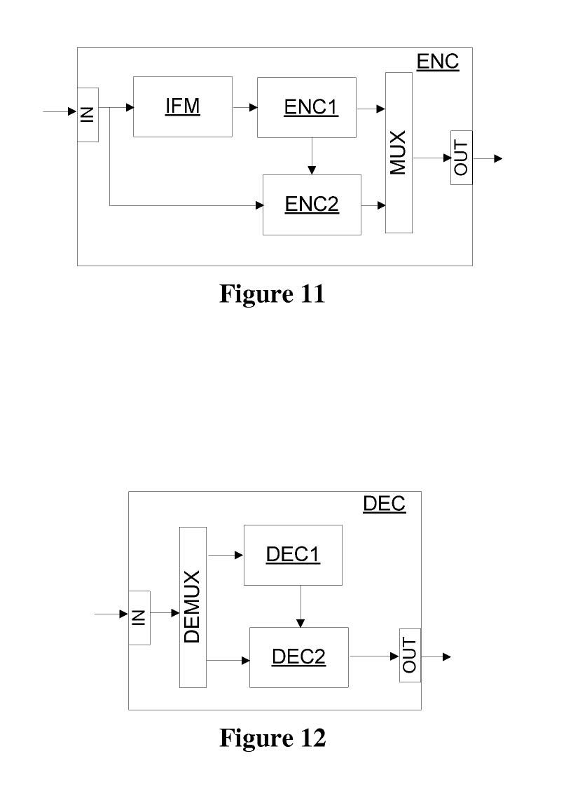

FIG. 11 represents a coding device according to the invention. On a first input IN, the coding device ENC receives a current image Icurr. The input IN is linked to a IFM. The module IFM is adapted to create a summary of the current image Icurr according to step 20 of the encoding method. The image factorization module IFM is linked to a first encoding module ENC1. The first encoding module ENC1 is adapted to encode the summary into a first bitstream according to step 22 of the encoding method. The coding device ENC further comprises a second encoding module ENC2 linked to the first encoding module ENC1. The second encoding module ENC2 is adapted to encode the current image into a second bitstream according to steps 24, 26 and 28 of the encoding method. In particular, the second encoding module ENC2 is adapted to decode the image summary encoded with the first encoding module ENC1, to reconstruct an intermediate image from the decoded summary and to encode the current image Icurr using the intermediate image as reference image. The encoding device ENC may further comprises a multiplexing module MUX adapted to multiplex the first and second bitstreams into a single bitstream or transport stream. In this case the multiplexing module is linked to a single output OUT. According to a variant, the multiplexing module is external to the coding device which then comprises two outputs, one for the first bitstream and one for the second bitstream.

FIG. 12 represents a decoding device DEC according to the invention. The decoding device receives on a first input IN a bitstream. The input is linked to a demultiplexing module DEMUX. The demultiplexing module DEMUX is adapted to demultiplex the bitstream into a first bitstream representative of an image summary and a second bitstream representative of residues, or more precisely of prediction error residual. According to a variant the demultiplexing module DEMUX is external to the decoding device which then comprises two inputs, one for the first bitstream and one for the second bitstream. The decoding device DEC further comprises a first decoding module DEC1 adapted for decoding an image summary from the first bitstream according to step 32 of the reconstruction method. It further comprises a second decoding module DEC2 linked to the first decoding module DEC1. The second decoding module DEC2 is adapted to reconstruct the current image from the second bitstream according to steps 34, 36 and 38 of the reconstruction method. In particular, the second decoding module DEC2 is adapted to reconstruct an intermediate image from the decoded summary and to reconstruct the current image Icurr using the intermediate image as reference image.

Compared to existing methods based on intra coding, the invention has the advantages to improve the Rate Distortion performance. The main characteristics of the invention is the use of an image summary to predict a current image to be encoded where the image summary, e.g. the epitome gives a reconstructed image, this reconstructed image (normal size, i.e. the same size as the size of the original image from which the epitome is created) being used as reference image in a video encoder. Advantageously, the reconstructed image is of same size as the image to encode. Therefore, efficient mode such as known “skip mode” may be used to encode blocks in the current image thus decreasing its encoding cost.

The main targeted applications of the invention are the video distribution (including compression) and the display technologies applications related to video compression.

First the invention is not limited by the encoding method used to code the residue (i.e. the difference between a block and a corresponding block in the reference image) computed for a current image. In addition, the method is not at all limited to the method used for constructing the epitome, i.e. the texture epitome and the assignation map. Indeed, the method of coding according to the invention only requires for an image to be encoded an image summary whatever the method used to create the summary.

1. A method of coding a sequence of images comprising for a current image:
creating a summary of said current image;
encoding said summary into a first bitstream;
further comprising:
reconstructing an intermediate image of same size as said current image from said summary; and
encoding, into a second bitstream, the current image using said intermediate image as reference image.

2. The method of coding according to claim 1, wherein the summary of said current image comprises a texture epitome and an assignation map.

3. The method of according to claim 2, wherein said assignation map is encoded using fixed length coding.

4. The method of coding according to claim 2, wherein said assignation map is encoded using variable length coding.

5. The method of coding according to claim 1, wherein said second bitstream is in conformance with one video coding standard belonging to the set of video coding standards comprising :
ITU-T Rec. H.264/ISO/IEC 14496-10 AVC video coding Standard; and
ISO/IEC 13818-2 MPEG2.

6. A method of decoding an image summary for the reconstruction of a sequence of images comprising for a current image:
decoding an image summary of said current image;
further comprising:
reconstructing an intermediate image from said summary; and
reconstructing said current image using said intermediate image as reference image, said intermediate image being of same size as said current image.

7. The method of decoding according to claim 6, wherein the summary of said current image comprises a texture epitome and an assignation map.

8. The method of decoding according to claim 7, wherein said assignation map is decoded using fixed length decoding.

9. The method of decoding according to claim 7, wherein said assignation map is decoded using variable length decoding.

10. A device for coding a sequence of images comprising:
a module configured to create a summary of a current image;
a module configured to encode said summary into a first bitstream;
further comprising:
a module configured to reconstruct an intermediate image of same size as said current image from said summary; and
a module configured to encode, into a second bitstream, the current image using said intermediate image as reference image.

11. A device for decoding an image summary for the reconstruction of a sequence of images comprising:
a module configured to decode an image summary of said current image;
further comprising:
a module configured to reconstruct an intermediate image from said summary; and
a module configured to reconstruct said current image using said intermediate image as reference image, said intermediate image being of same size as said current image.
